(19) United States
(12) Patent Application Publication
(10) Pub. No.: US 2020/0148175 A1
(43) Pub. Date: May 14, 2020

(54) WASHING INSTALLATION WITH REGULATABLE METERING

(71) Applicant: Washtec Holding GmbH, Augsburg (DE)

(72) Inventors: Stefan Mayer, Neusaess (DE); Andreas Sattler, Muenchen (DE); Bernhard Heinz, Gersthofen (DE)

(21) Appl. No.: 16/740,056

(22) Filed: Jan. 10, 2020

Related U.S. Application Data
(63) Continuation of application No. PCT/EP2018/068539, filed on Jul. 9, 2018.

(30) Foreign Application Priority Data
Jul. 10, 2017 (DE) 10 2017 115 345.4

(51) Int. Cl. B60S 3/04; B05B 12/14

(52) U.S. Cl. CPC B60S 3/04; B05B 12/1436

(57) ABSTRACT

An electronically regulatable metering pump for use in an automatic washing installation is regulated based on a desired specification of the washing installation and depending on detected sensor data and is configured to deliver a volume flow of the additive such that, when the additive is admixed with the washing fluid, a desired application concentration is provided for feeding into an operating assembly of the washing installation.

### CROSS REFERENCE TO RELATED APPLICATIONS

This application is a continuation application of international patent application PCT/EP2018/068539, filed Jul. 9, 2018, designating the United States and claiming priority to German application 10 2017 115 345.4, filed Jul. 10, 2017, and the entire content of both applications is incorporated herein by reference.

### TECHNICAL FIELD

The present disclosure relates to a washing installation for vehicles, in which a chemical additive or an admixture is added to a washing fluid, such as, e.g., water, to a method for operating such a washing installation and to a metering pump.

### BACKGROUND

When washing vehicles, different chemical additives, such as, e.g., shampoos, rim cleaners, are admixed in a particular concentration to the washing fluid in order to improve the washing result. In order for the desired concentration to be achieved, it is known to use a metering pump.

For instance, EP 2,885,169 B1 describes a metering device, as known from the prior art. It cooperates with a control device in order for the metering amount to be able to be controlled in accordance with fixed specifications.

Corresponding containers and cartridges for providing the additives are known from EP 2 024 238 and EP 2 136 938.

The previous metering devices have proved to be disadvantageous in that the options for adapting to changed system states during operation of the washing installation are only extremely limited. This can result in incorrect metering and as a result high maintenance costs and avoidable shutdown times. Previously, when system conditions are changed, the system had to be newly calibrated each time. For example, if the supply pressure in a water inlet line had changed, then the metering pump in the prior art had to be newly actuated in order to obtain the desired application concentration for the changed system state (different water pressure).

### SUMMARY

Proceeding from this prior art, it is an object of the present disclosure is to operate a washing installation such that the desired application concentration of the additive in the washing fluid can be provided in a constant or designated manner even when the operating conditions are variable. In addition, the service costs should be reduced.

According to a first aspect of the disclosure, the object is achieved by a washing installation for vehicles, including:

a supply connection for supplying the washing fluid (e.g., treatment fluid, generally water),

a sensor unit for detecting sensor data which is configured in particular as a volume flow measuring device and to measure a supply-side volume flow of the washing fluid,

a storage container for an additive (a chemical washing substance such as, e.g., a rim cleaner, a wax, shampoo, etc.) to be admixed into the washing fluid,

an electronically regulatable metering pump to deliver an regulatable volume flow of the additive;

an electronic circuit unit having an interface for detecting a desired application concentration of the additive in the washing fluid, wherein the electronic circuit unit to regulate the metering pump in that a desired specification for the metering pump is calculated such that by a volume flow ratio between the measured volume flow of the washing fluid and the volume flow of the additive delivered by the metering pump, the detected, desired application concentration is achieved for feeding into operating assemblies of the washing installation (e.g., a spraying system).

The additive is a chemical additive which is added to the water in a metered manner. It can be provided in liquid form (as a concentrate), as a paste or as a powder. Mixing and centrifugal chambers can be provided for the metered mixing of additive and washing fluid.

The desired specification is a set of commands sent by the electronic circuit unit to the metering pump for execution. It indicates which volumes the pump should deliver (indicated as litres/unit of time, e.g., 2.81/h or 46.7 ml/min). The desired specification characterizes the pump capacity (when the pump is operating normally). In the event of a malfunction, the pump capacity can be detected by a sensor (e.g., by a volume flow measuring device) and be compared with the desired specification in order to initiate diagnostic and other measures fixing the malfunction.

In an exemplary embodiment of the disclosure, the washing installation includes a valve assembly which is engaged with an inlet line or the supply of washing fluid and which is used to adapt the delivered washing fluid and for this purpose is controlled and/or regulated by the electronic circuit unit. This design has the advantage that a further option for adapting to changed operating conditions is possible. For instance, e.g., in the case of increased water supply pressure, the flow can be restricted via an actuatable restrictor valve.

In a further exemplary embodiment of the disclosure, the valve assembly is actuated electromechanically. In an alternative exemplary embodiment of the disclosure, the valve assembly can also be actuated in a purely electrical or hydraulic manner. The control signals are outputted by the electronic circuit unit of the washing installation. This has the advantage that the actuation of the valve assembly can be taken into account at the same time as the regulation of the metering pump.

In another exemplary embodiment of the disclosure, the application concentration of the additive in the washing fluid provided by the metering pump is distributed via a distributor valve assembly for selectively feeding into selected operating assemblies of the washing installation and in particular into selected spray nozzles of a spraying system in a dedicated manner for each process step of the washing installation. This advantageously results in the fact that the spray nozzles can be regulated in a very specific manner and also differently for each process step (of course they can also be regulated consistently).

In another exemplary embodiment of the disclosure, the washing installation also includes a second sensor unit for detecting metering pump-related operating state data. The operating state data relate to the operating state of the metering pump. Said data can include in particular metering pump capacity and/or a volume flow of the additive delivered by the metering pump. Said data can further include error status messages, temperature signals and/or pressure and path measurement signals of components of the metering pump.

In another exemplary embodiment of the disclosure, the electronic circuit unit includes:

an input interface to detect measured sensor data of at least one supply-side volume flow measuring device,

an interface for detecting the desired application concentration of the additive in the washing fluid, and an output interface to output a desired specification for regulating the metering pump.

In an exemplary embodiment of the disclosure, the washing installation and/or the electronic circuit unit thereof includes a user interface for outputting regulating information, error information and/or other data.

In another exemplary embodiment of the disclosure, the input interface is further configured to detect other sensor data. It can also include a network interface for detecting other regulating data. Therefore, yet more data can advantageously be considered for regulation purposes, such as, e.g., whether data retrieved from an on-line database, said data indicating the amount of dirt. In addition or alternatively, driving profile data can be read in and evaluated and considered for the regulating task.

The output interface can include an actuator interface in order to actuate or regulate other actuators of the washing installation. The output interface can include an actuator interface in order to actuate other actuators of the washing installation, e.g., distributor valves, in order to divide the application concentration of the admixture among different spray branches of the spraying system. Furthermore, pressure control valves can be used.

In another exemplary embodiment of the disclosure, the sensor unit of the washing installation includes a volume flow measuring device and/or a pressure measuring device. By additionally detecting pressure measuring data (as sensor data), different advantages can be achieved. For instance, the measured volume flow and the measured pressure can be supplied to a diagnostic unit in order to be able to perform targeted, technical troubleshooting and diagnostics. Typically, the diagnostic unit is implemented as a software diagnostic module and can be implemented directly in the controller. If, e.g., a high volume flow at a very low pressure is measured, then this indicates a malfunction which can be traced back to a defective supply of pressure (e.g., a coupling defect). Otherwise, if a low volume flow at a very high pressure is measured, then this can be traced back to an obstruction in the spray nozzles. A corresponding technical diagnosis can be output on a user interface and/or forwarded to a maintenance system (via a network connection). Therefore, malfunctions can be recognized directly and immediately on the installation and the use of a service technician can be avoided.

According to a further aspect, the disclosure relates to an electronically regulatable metering pump for use in a washing installation. The metering pump, as already described above, is configured to deliver a volume flow of the additive such that, when the additive is admixed with the washing fluid, a desired application concentration is provided even when the system state and in particular the volume flow and/or the pressure of the supplied washing fluid changes. The mixture of washing fluid and additive in a desired metered amount is used for feeding into an operating assembly of the washing installation. For this purpose, the metering pump is regulated in accordance with a desired specification. The desired specification is calculated in dependence upon currently detected sensor data from the electronic circuit unit. The quantity of detected sensor data characterizes the system state. For instance, e.g., a first system state is defined at a first volume flow of the washing fluid and at a first ambient temperature and at a first water supply pressure and at a first amount of dirt, whilst a second system state is defined by a second volume flow, by a second ambient temperature, by a second water supply pressure and by a second amount of dirt, etc. The regulation of the metering pump DP can thus be adapted to the currently detected system state. The sensor data and parameters which are detected for defining the system state can be predefined. The regulation is effected at least in dependence upon the detected volume flow of the washing fluid.

In an exemplary embodiment, the electronically regulatable metering pump is provided for use in an automatic washing installation which is regulated on the basis of a desired specification of the washing installation and in dependence upon detected sensor data and is intended to deliver a volume flow of the additive such that, when the additive is admixed with the washing fluid, a desired application concentration is provided which is intended in particular for feeding into an operating assembly of the washing installation.

In an exemplary embodiment of the metering pump, the operating assembly includes a spraying system having a quantity of spray nozzles.

In an exemplary embodiment of the metering pump, the desired specification for the volume flow, to be delivered, of the metering pump is provided and regulated by an electronic circuit unit of the washing installation.

In an exemplary embodiment of the metering pump, the metering pump can exchange data with an electronic circuit unit of the washing installation via a bus system in order to regulate the metering pump.

The operating assembly can be, e.g., a spraying system having a quantity of spray nozzles. The designs of the spraying system can be different depending upon the application. Typically, at least one spray branch is provided for each side, said branch being able to include a plurality of spray nozzles. Depending upon the process step in washing operation, the individual spray nozzles can be selectively activated (e.g., switched on or switched off by a corresponding valve controller). An operating assembly can be fed by one or a plurality of metering pumps (supplied, e.g., with different additives). A metering pump can also be designed to feed a plurality of operating assemblies. An important advantage of the present disclosure is that the application concentration of the additive in the washing fluid can be regulated in a separate and variable manner for each process step.

In an exemplary embodiment of the disclosure, a desired specification for the volume flow, to be delivered, of the metering pump is provided and regulated by an electronic circuit unit of the washing installation. If a plurality of metering pumps are provided for the same spraying system or for different spraying systems, then the metering pumps can be regulated typically centrally by the electronic circuit unit (e.g., with a microcontroller) of the washing installation. If a plurality of metering pumps are used, these can also be regulated selectively in order to fulfil a superordinate task which relates to a plurality of operating assemblies. For instance, e.g., in the case of rims which are very dirty, initially a higher metered amount of additive or a higher application concentration thereof can be indicated for those spraying arms which clean the rims (on the right and left). After an exposure time, a smaller application concentration can be applied in a subsequent process step. However, other spray arms which are fed by other metering pumps can be operated in parallel with another admixture and/or with another application concentration of the additive.

In another exemplary embodiment of the disclosure, the metering pump exchanges data with the electronic circuit unit of the washing installation via a bus system (in particular a CAN bus) for regulating the metering pump. The bus system can be configured to transfer the sensor signals such as, e.g., the measured volume flow of the additive and/or the washing fluid to the circuit unit and can also be configured to transmit the desired specifications for the regulation to the metering pump.

According to a further aspect, the disclosure relates to a method for operating a washing installation having an electronically regulatable metering pump, including the following method steps:

detecting (measuring or reading-in, e.g., from a digital memory) sensor data, in particular a measured volume flow of a washing fluid,

reading-in a desired application concentration of the additive in the washing fluid, and

regulating a desired specification for the metering pump for delivering a volume flow of the additive such that the read-in desired application concentration can be provided in dependence upon the detected sensor data and in particular in dependence upon a varying volume flow of the washing fluid.

According to an exemplary embodiment of the disclosure, a volume flow of the additive delivered by the metering pump is measured in order to regulate the metering pump on the basis of a volume flow ratio, i.e., the ratio between volume flow-washing fluid and volume flow-additive) in terms of the desired application concentration. Therefore, incorrect mixing ratios which result, e.g., from changed system conditions (e.g., a change in water volume flow) can be avoided.

In a further exemplary embodiment of the disclosure, time schedule-based regulation is performed. Therefore, the application concentration can be adaptively regulated in a varying manner over time and can be regulated in particular in a varying manner within a spraying cycle. Therefore, the regulation can be adapted even better to the application situation. In addition, costs can be saved and the environment can be protected, in that an excessive application concentration of the admixture can be avoided.

In a further exemplary embodiment of the disclosure, a position-based regulation is performed, in that the washing installation includes a plurality of metering pumps which are regulated separately or individually in each case and so the application concentration is specified adaptively and individually for operating the operating assemblies fed by the respective metering pump. Therefore, the application concentration can be regulated in a varying and adaptive manner even for selected ones or all spray branches (or even individually for each spray nozzle of the washing installation if these are each supplied individually by one metering pump). Therefore, the regulation can also be adapted better and even more specifically to the application situation. Alternatively or cumulatively, a plurality of operating assemblies can be fed by one metering pump, the application concentration of the assemblies being able to be regulated as described above and the assemblies being able to be activated (or switched on) or deactivated (switched off) by a corresponding valve assembly.

In a further exemplary embodiment of the disclosure, the application concentration (of the added additive in water) is regulated in an individual and separate manner for each process step of the washing installation. Therefore, a substantially more precise regulation of the metering pump can be achieved.

It is possible to use a plurality of metering pumps in one washing installation. Each of these metering pumps can advantageously be regulated individually by the electronic circuit unit. Advantageously, technical interdependencies of the metering pumps can also be considered for the regulation. It may be necessary, e.g., with a high use of pre-cleaners, to increase the application concentration of the subsequently applied drying aid in order to achieve optimum dewetting of the vehicle by the washing liquor prior to fan drying.

In a further exemplary embodiment of the disclosure, the metering pump is also regulated in the event of changed system conditions, such as, e.g., a fluctuating washing fluid pressure and/or in the event of changes in the spraying system and/or in consideration of other disturbance variables in such a manner that the desired application concentration is achieved. New calibration of the system is no longer required. The system reacts automatically to system changes and disturbance variables.

In a further exemplary embodiment of the disclosure, a pressure of the washing fluid is additionally detected as sensor data, in addition to the volume flow. Detection can be performed by a pressure sensor in the water supply line. This has the advantage that error-diagnostic information can be calculated and provided from the ratio of the detected sensor data.

### BRIEF DESCRIPTION OF THE DRAWINGS

The disclosure will now be described with reference to the drawings wherein:

FIG. 1 shows a schematic overview of an automatic washing installation according to an exemplary embodiment of the disclosure;

FIG. 2 shows a schematic drawing of the electronic units according to an exemplary embodiment of the disclosure;

FIG. 3 shows a flow diagram of a method for operating a washing installation having a regulated metering pump according to an exemplary embodiment of the disclosure; and

FIG. 4 shows a schematic overview figure including a line system for washing fluid and additive and electrical connections.

### DESCRIPTION OF EXEMPLARY EMBODIMENTS

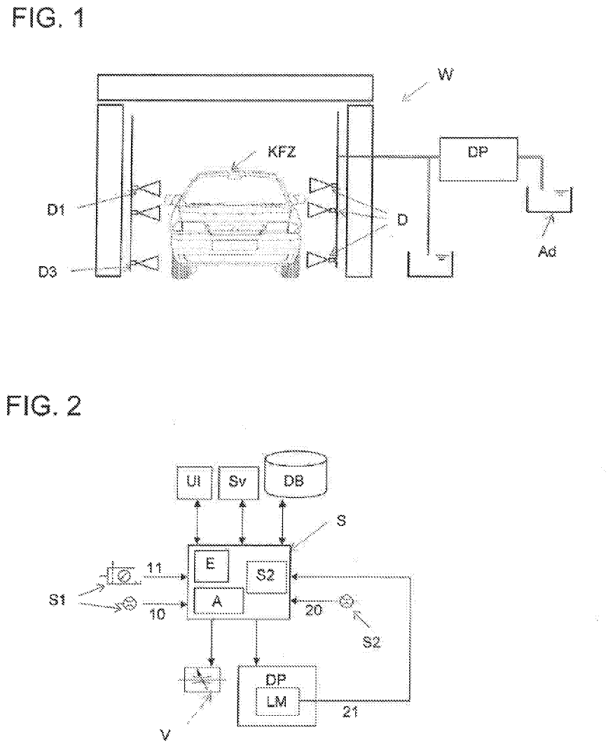

FIG. 1 shows a schematic overview of a washing installation W having an electronically regulatable metering pump DP according to an exemplary embodiment of the disclosure.

The metering pump DP is used to deliver an additive in a particular amount. The additive is stored in a storage container Ad (in FIG. 1: the right upper container) and the washing fluid can be stored in a separate storage container (in FIG. 1: the left lower container on the right-hand side).

The washing installation is an automatic washing installation, typically a portal washing installation for a vehicle KFZ having two side brushes and a ceiling brush which are shown schematically in FIG. 1. The washing installation further includes a plurality of operating assemblies, such as inter alia brushes and a spraying system D. The spraying system D can be arranged symmetrically on both sides of the machine and typically includes a plurality of spray nozzles D1, D2, D3 . . . Dn. The number and arrangement of spray nozzles Di is irrelevant for the present disclosure. The important factor is that the spray nozzles are fed by a mixture which is a mixture of a washing fluid and an added additive. The washing fluid is typically fresh water or recycled water. The additive can be, e.g., chemical substances such as a rim cleaner which is provided in a high concentration. Other applications require the admixing of foaming agents, insect removers, drying aids or a wax.

The additive should be fed-in in a particular desired application concentration in the operating assembly of the washing installation W. “Application concentration” is thus intended to mean herein the ratio of the mixture (washing fluid plus added additive) to washing fluid. The desired application concentration can be input by the user via a human-machine interface which is connected to an electronic control unit S. Typically, the user interface UI is arranged on the machine (washing installation W). The desired application concentration can also be automatically calculated by a computing unit by accessing a server SV with stored allocations (of parameters which characterize the operating state and of a corresponding desired specification).

Since the additive is provided in a highly-concentrated manner, a metering pump DP is provided which delivers the additive from the storage container Ad in a particular metered amount and admixes it with the water. The mixture (washing fluid+additive) is then fed to the spraying system D. In FIG. 1, the metering pump DP removes the additive from a storage container Ad illustrated on the right in the figure and feeds it into a feed line in a particular metered amount. As shown in FIG. 1, the washing installation W is supplied with water or washing fluid from a further container via a supply connection. The additive is also fed into a feed line connected to this supply connection and so the mixture has a desired application concentration in order to provide a washing performance which is as optimum as possible depending upon the location (position of the spray nozzle) and time (process step).

Depending upon the process step, it is possible in accordance with an exemplary embodiment of the disclosure to regulate different application concentrations, namely depending upon the respective operating state. This means that even disturbance variables, such as, e.g., a fluctuating water supply pressure and/or a changed water volume flow, can be considered during the regulation task and so even when the system state is changed (changed volume flow, pump capacity, etc.) a constant application concentration or an application concentration according to a desired time cycle is nevertheless achieved.

For this purpose, two regulating circuits are provided:

1. a first regulating circuit of the metering pump DP, and

2. a second regulating circuit of the washing installation W.

The aim is to provide a desired application concentration of the additive in water, by which the spray nozzles are operated.

This aim was previously achieved by using a controller. A corresponding specification was fixedly set and the system was operated with this setting. However, in practice it has been shown that the system is very prone to malfunction owing to changed system conditions, such as, e.g., a changed water volume flow. The metering pump being used was calibrated for a particular operating state (e.g., for a particular water volume flow). If the operating state changed and the metering pump was not newly calibrated, then in the known systems in the prior art the application concentration changed accordingly which ultimately resulted in a poor washing result or excess additive consumption. In turn, this could cause consequential malfunctions.

These malfunctions can be avoided by the solution provided herein, in that the desired specification for the metering pump DP is regulated by the electronic circuit unit S (FIG. 2).

FIG. 2 shows a schematic illustration of the electronic circuit unit S exchanging data with the metering pump DP. The arrows shown in FIG. 2 are electrical connections for analogue and/or digital signals within the regulation process.

The metering pump DP obtains, from the electronic circuit unit S, a desired specification for delivering the additive in a particular metered amount. This desired specification is calculated by the second regulating circuit. The second regulating circuit is implemented in the electronic circuit unit S. By a volume flow measuring device, the volume flow of the water supply is measured and is supplied as a water volume flow signal 10 to the electronic circuit unit S for use in the regulating circuit. Alternatively or cumulatively, a pressure measuring device can be formed as a further sensor device S1 in order to measure the water pressure and to be supplied as a water pressure signal 11 to the electronic circuit unit S. This proves to be particularly useful if other technical diagnostic data which can be determined by comparing the two variables are to be calculated. For instance, e.g., a high pressure at a low volume can indicate constriction points in the connection system (e.g., obstructed nozzles) or vice-versa: a low pressure at a high volume can indicate a leak or another malfunction.

The user can input a desired application concentration via a user interface UI or said concentration can also be automatically calculated by the system from other variables. For this purpose, the electronic circuit unit S can access a server Sv containing weather data and/or drive profile data via a network interface (e.g., UMTS module) and calculate an application concentration on the basis thereof. The electronic circuit unit S can also access stored rules in a database DB.

The metering pump DP includes the first regulating circuit and can include a capacity meter LM. This is used to detect, within the metering pump, the capacity of the metering pump which can be calculated from the process data of the pump DP and other sensor data (number of strokes, stroke volume, etc.). The corresponding signal can be sent as a metering pump capacity 21 to the electronic circuit unit S in order to be able to diagnose malfunctions of the metering pump DP. Typically, normal operation is presumed such that the desired specification (designated in FIG. 2 by the arrow pointing downwards) sent by the electronic circuit unit S to the metering pump DP corresponds to the metering pump capacity.

In a further exemplary embodiment, another sensor unit S2 can be arranged in a line region downstream, i.e., after the metering pump DP, in order to determine the volume of additive actually delivered by the metering pump DP. This volume flow measurement signal 20 can also be sent to the electronic circuit unit S in order to be able to diagnose malfunctions of the metering pump DP.

The electronic circuit unit S can also actuate or regulate one or more valve assemblies V which are arranged in the supply line in the flow direction upstream of the metering pump DP. FIG. 2 shows a restrictor valve by way of example. The valve assembly V can also include other valves (e.g., for pressure regulation). Typically, the components of the valve assembly V can be actuated electronically. For this purpose, they are supplied with corresponding commands by the electronic circuit unit S.

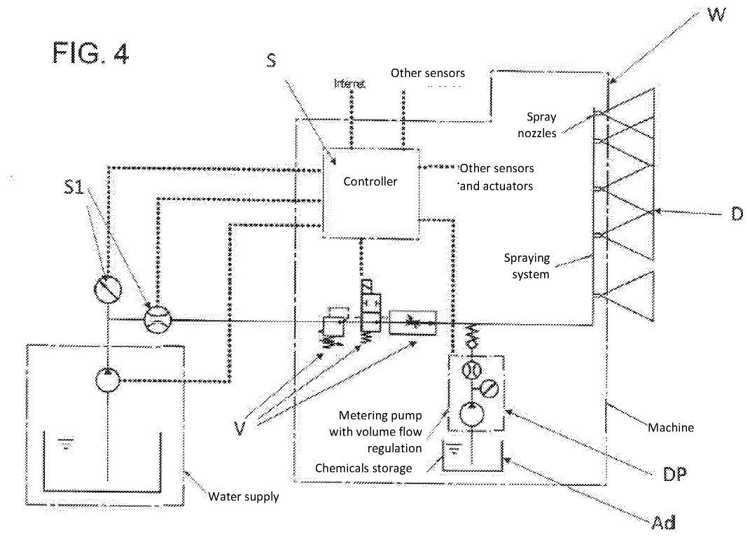

As shown in FIG. 4, the washing installation W (which is designated in FIG. 4 as a machine with the dot-dash line) includes a supply connection in order to supply water. The lines shown as dots in FIG. 4 relate to the signal and/or data exchange. The water can be pumped from a tank, shown on the left-hand side, in the solid line extending horizontally in FIG. 4, this line representing the supply line. A volume flow measuring device is arranged on this water supply or infeed line. In addition, a pressure measuring device can also be provided as a sensor device S1. Valve assemblies V are arranged on the water supply line and are designated by the reference sign V in FIG. 4. They can be formed, e.g., for pressure regulation (pressure limiting valve) or as 2-port/2-way valve for selectively distributing the mixture to different spray nozzles Di. Furthermore, a restrictor valve can also be used. The mixture is distributed to the respective spray nozzles Di. For this purpose, a distributor circuit can be formed. The valves can be controlled electronically by the electronic circuit unit S.

The metering pump DP is used to feed the additive in a particular metered amount/application concentration into this water supply line. Depending upon which sensor signals (type and value) have been detected by the electronic circuit unit S (in particular in dependence upon the detected water volume flow), the desired specification for the metering pump DP is now calculated and is forwarded thereto in a set of commands. The pump DP is then operated with this desired specification for as long as the system state remains unchanged. As soon as the system state changes (e.g., amended water volume flow), the desired specification is corrected accordingly in order to achieve the desired application concentration. The sensor signals are fed back to the regulating circuit. If an amended volume flow is thus detected, a correspondingly adapted desired specification can be immediately and automatically calculated for metering through the metering pump and can be forwarded to the metering pump for execution. Manual adaptation is no longer required.

In a further exemplary embodiment, on the pump-side yet another sensor unit S2 can be formed which is used to detect metering pump-related signals. For instance, it is e.g. possible to detect the pump capacity or to calculate the same from process data of the respective pump. Furthermore, a further volume flowmeter can be used to detect the amount of additive actually delivered by the metering pump. This is arranged downstream and thus “after” the metering pump DP. The data detected using these measuring devices or the calculated data are fed back to the electronic circuit unit S for regulation purposes.

In a further exemplary embodiment of the disclosure, other pump data are sent by the metering pump to the electronic circuit unit S. These can be, e.g., malfunction notifications (e.g., in the case of a short-circuit), pressure and counter-pressure details and/or temperature data. These data are used by circuit logic formed on the electronic circuit unit S for calculating a result which can be output, e.g., on the user interface UI. Therefore, the respective source of the malfunction can be recognized quickly and simply and can be eliminated on site.

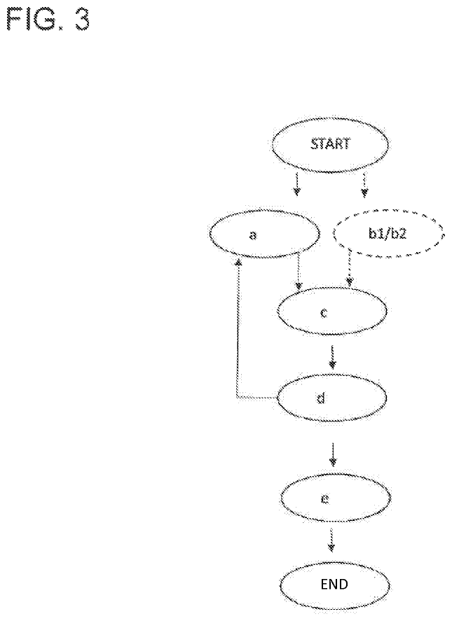

FIG. 3 shows a flow diagram for operating a portal vehicle washing installation 1. After the start of the method, a volume flow (water) is measured in step a. In more extensive designs, yet other sensor data can optionally be detected (e.g., measuring the water supply pressure). It is also possible to calculate the pressure from the measured volume flow. Optionally, pump-side sensor data can also be detected in step b1 or calculated in step b2 (such as, e.g., a calculated volume flow of the additive delivered by the metering pump DP). Because these are merely optional options, these are shown as dashed lines in FIG. 3. In step c, the desired application concentration (of the additive in the washing fluid) is read-in or detected. This can also occur at an earlier point in time. On the basis of the sensor data and the target specifications for the application concentration, a desired specification is then calculated for the metering pump DP and is forwarded thereto in step d for regulation purposes. By considering the currently detected sensor data, it can be ensured that the desired application concentration is maintained in a corresponding manner, even when the system conditions are changed (higher/lower water pressure). The method can terminate thereafter. Alternatively, in step e for the purpose of diagnosis an output of the calculated desired specification and/or the detected sensor data and/or the read-in sensor data of the metering pump DP can be output on a user interface.

In an exemplary embodiment of the disclosure, the two regulating circuits are interconnected in a cascaded manner. The second regulating circuit of the washing installation W provides, together with the desired application concentration, the desired specification for the first regulating circuit of the metering pump DP. Counter pressure, stroke length (stroke volume) and the number of strokes can be measured in the first regulating circuit of the metering pump in order to regulate the metering capacity corresponding to the desired specification. However, the pump capacity can also be calculated from the process data of the pump DP. In the simplest case, the metering pump is controlled on the basis of the calculated desired specification.

Additional control elements (e.g., a compressed air supply having an electrically actuatable proportional valve for the compressed air and a compressed air gauge for generating foam) can also be integrated in the inlet system.

By the option for regulating the metering or the application concentration (of the additive in the washing fluid) in dependence upon the system state (pressure and/or volume, spray nozzle state), the application concentration can also be kept constant or can be regulated according to the desired specification even when the conditions are changed. Furthermore, the spray nozzles Di of the spraying system can be operated selectively with different application concentrations (e.g., higher concentration for the rim nozzles and lower concentration for the upper nozzles). This can be achieved in that the individual spray nozzles are each supplied separately by a metering pump or in that the spray nozzles are supplied by the same metering pump but are activated or operated in different time phases in the washing process. It is also possible to specify different application concentrations for the individual process steps of the vehicle washing process (e.g., higher application concentration for the nozzles D in the front region and/or during forwards travel of the portal and lower concentration for the nozzles in the rear region and/or during reverse travel). The application concentration can thus be regulated in dependence upon the position of the spray nozzle D and/or in dependence upon a point in time in the washing process. For instance, it is particularly possible to transmit, in the desired specification, not only a constant value (for the metering volume to be delivered), but also a signal curve over time. Therefore, it becomes possible to regulate the application concentration in a varying manner over time (even in one process step) (e.g., a higher application concentration at the beginning and a lower application concentration subsequently).

One possible exemplary embodiment of the regulating task for the metering pump DP on the basis of the measured volume flow of the washing fluid was described above. Other exemplary embodiments make provision for the detection or reading-in of other sensor signals, and for the execution of the regulation in response to these signals. For instance, e.g., the temperature can be measured, which can have an influence on the viscosity of the additive and possibly renders necessary metering which is changed in dependence upon the temperature (e.g., higher metering may be indicated in the event of a lower temperature). The temperature of the body of the vehicle KFZ can also be measured or detected and the metering pump DP can be regulated on the basis of this sensor signal. Furthermore, the position of the spray system D of the washing installation W in relation to the vehicle to be cleaned can be detected in order to regulate the metering pump DP in dependence thereupon. For instance, a higher application concentration may be applied in a first passage of the portal over the vehicle than in a second back passage of the portal.

The detected sensor signals and/or the other data are typically compiled and aggregated in the electronic circuit unit S. A plausibility check of the sensor data can be performed on the basis of the detected data. If, e.g., a measured value exceeds an average value by a predeterminable threshold value, then a repeated measurement may be requested in order to check whether this was a measurement outlier. If, in another case, a plurality of metering pumps DP are used, the temperature of each of which being detected, and two temperature measurement values approximately coincide with one another whilst the third value is significantly different, repeated temperature measurement and/or other measures can be initiated in order to detect a possible malfunction as early as possible.

The present disclosure relates to an automatic washing installation W for vehicles KFZ, having a volume flow measuring device for measuring a volume flow of a washing fluid; a metering pump DP for supplying an additive to the volume flow; and an electronic circuit unit S for regulating the metering pump DP in dependence upon the volume flow. As a result, the technical advantage is achieved that the additive can be added depending upon the varying volume flow of the washing fluid.

In addition, the washing installation includes a pressure measuring device for measuring the pressure of the washing fluid. The pressure measuring device can be arranged in the metering pump DP or can be part of the metering pump DP. The control unit S can additionally be configured to evaluate the measured volume flow and also the measured pressure. The control unit S can compare the measured pressure and the volume flow with electronically pre-stored values for a normal state, in order to determine a malfunction state of the washing installation.

If, e.g., a high volume flow at a low pressure is present compared with the pre-stored values, then a leak in the washing installation can be assumed as the malfunction state. In contrast, if a low volume flow at a high pressure is present compared with the pre-stored values, then an obstruction in the washing installation can be assumed as the malfunction state, such as, e.g., an obstruction in one or more spray nozzles.

The present disclosure also relates to a method for operating an automatic washing installation W for vehicles KFZ, including the steps of measuring a volume flow of a washing fluid, supplying an additive to the volume flow, and regulating a metering pump DP in dependence upon the volume flow. In addition, the pressure of the washing fluid can be measured. The measured pressure and the volume flow can be compared with electronically pre-stored values for a normal state, in order to determine a malfunction state of the washing installation.

All features explained and illustrated in conjunction with exemplary embodiments of the disclosure can be provided in a different combination in the subject matter in accordance with the disclosure in order to achieve the advantageous effects thereof at the same time.

All the method steps of the method can be implemented by electronic devices (circuits) which are suitable for carrying out the respective method step. Conversely, all functions which are carried out by features in relation to the installation can also be implemented in software and be a method step of a method. For instance, e.g., the method step “regulating” can be implemented by a regulating circuit module which has said corresponding functionality.

Typically, all the steps of the claimed method are performed on the electronic circuit unit S. The sensor data (volume flow) are measured on a separate device and the measurement data are detected on the electronic circuit unit S (i.e., read-in via an input interface E). However, it is also possible for individual method steps to be divided and/or swapped among individual modules. For instance, in particular the regulation can be performed on another computing unit which exchanges data with the electronic circuit unit S.

The scope of protection of the present disclosure is set by the claims and is not limited by the features explained in the description or shown in the figures.

It is understood that the foregoing description is that of the exemplary embodiments of the disclosure and that various changes and modifications may be made thereto without departing from the spirit and scope of the disclosure as defined in the appended claims.

What is claimed is:

1. An automatic washing installation for vehicles, the automatic washing installation comprising:
a supply connection for supplying a washing fluid;
a first sensor unit for detecting sensor data which is formed as a volume flow measuring device and is configured to measure a supply-side volume flow of the washing fluid;
a storage container for an additive to be admixed with the washing fluid;
an electronically regulatable metering pump to deliver a volume flow of the additive from the storage container; and
an electronic circuit unit having an interface for detecting a desired application concentration of the additive in the washing fluid, wherein the electronic circuit unit is configured to regulate the electronically regulatable metering pump depending on sensor data, in that a desired specification for the electronically regulatable metering pump is calculated such that by a volume flow ratio between a measured volume flow of the washing fluid and the volume flow of the additive delivered by the electronically regulatable metering pump, the desired application concentration is achieved for feeding into operating assemblies of the automatic washing installation.

2. The automatic washing installation as claimed in claim 1, further comprising:
a valve assembly engaged with a supply of washing fluid, configured to adapt the volume flow of the washing fluid, and controlled and/or regulated by the electronic circuit unit.

3. The automatic washing installation as claimed in claim 1, further comprising:
a second sensor unit for detecting metering pump-related operating state data, in particular a metering pump capacity and/or the volume flow of the additive delivered by the electronically regulatable metering pump, and for detecting error status messages, temperature signals and/or pressure and path measurement signals.

4. The automatic washing installation as claimed in claim 1, wherein the desired application concentration of the additive in the washing fluid provided by the electronically regulatable metering pump is distributed via a distributor valve assembly for selectively feeding into selected operating assemblies of the automatic washing installation and in particular into selected spray nozzles of a spraying system in a dedicated manner for each process step of the automatic washing installation.

5. The automatic washing installation as claimed in claim 1, wherein the electronic circuit unit comprises:
an input interface to detect measured sensor data of at least one volume flow measuring device;
an interface to detect the desired application concentration of the additive in the washing fluid; and
an output interface to output the desired specification for regulating the electronically regulatable metering pump.

6. The automatic washing installation as claimed in claim 5, wherein the input interface is further configured to detect other sensor data and/or includes a network interface for detecting other regulating data.

7. The automatic washing installation as claimed in claim 1, wherein the first sensor unit of the automatic washing installation additionally includes a pressure measuring device.

8. A method for operating a washing installation having at least one electronically regulatable metering pump, the method comprising:
detecting sensor data, including detecting a measured volume flow of a washing fluid;
reading-in a desired application concentration of an additive in the washing fluid;
regulating a desired specification for the at least one electronically regulatable metering pump for delivering a volume flow of the additive such that the desired application concentration is achieved depending on detected sensor data and depending on the measured volume flow of the washing fluid; and
calculating the desired specification for the at least one electronically regulatable metering pump such that by a volume flow ratio between the measured volume flow of the washing fluid and the volume flow of the additive delivered by the at least one electronically regulatable metering pump the desired application concentration is achieved for feeding into operating assemblies of the washing installation.

9. The method as claimed in the claim 8, further comprising:
measuring, by the at least one electronically regulatable metering pump, or calculating, from process data of the at least one electronically regulatable metering pump, the volume flow of the additive delivered.

10. The method as claimed in claim 8, further comprising:
regulating the at least one electronically regulatable metering pump depending on a varying system state depending on sensor data and a changed washing fluid volume flow, and in view of the desired application concentration.

11. The method as claimed in claim 8, further comprising:
performing time schedule-based regulation such that the desired application concentration is adaptively regulatable in a varying manner over time according to the desired specification and such that the desired application concentration is regulatable in the varying manner within a spraying cycle.

12. The method as claimed in claim 8, further comprising:
performing a position-based regulation, in that the washing installation includes a plurality of metering pumps which are regulated separately such that the desired application concentration is provided adaptively and individually for operating the operating assemblies fed by a respective metering pump.

13. The method as claimed in claim 8, further comprising:
reading-in the desired application concentration individually and separately for each process step of the washing installation.

14. The method as claimed in claim 8, wherein the desired application concentration is regulatable even when a washing fluid pressure fluctuates and/or a spraying system changes and/or in consideration of other disturbance variables.

15. The method as claimed in claim 8, further comprising:
detecting a pressure of the washing fluid as sensor data in addition to the volume flow of the washing fluid, in order to calculate and provide error-diagnostic information from a ratio of the detected sensor data.
